(19) United States
(12) Patent Application Publication
(10) Pub. No.: US 2008/0022071 A1
(43) Pub. Date: Jan. 24, 2008

(54) Computerized system for simultaneous operation of multiple environments securing and separating digitally stored data

(76) Inventor: Mark Andrew Reid, Truro (CA)

Correspondence Address: Mark Andrew Reid, 30 Eaton Drive, Truro Nova Scotia, B2N 7H1, CA

(21) Appl. No.: 10/876,561

(22) Filed: Jun. 28, 2004

Related U.S. Application Data
(60) Provisional application No. 60/483,120, filed on Jun. 30, 2003.

(51) Int. Cl. G06F 9/30

(52) U.S. Cl. 712/206

(57) ABSTRACT

A computerized system for simultaneous operation of multiple environments and method for storing distinct data types separately is disclosed. The computerized system includes a plurality of main host, sub-host, data storage and network devices wherein data of a first type is stored on main host, data storage and network devices and data of a second type is stored on one of the sub-host, data storage and network devices, wherein data of a third type is stored on at least another one of the sub-host, data storage and network devices, and data of a forth type is stored on at least another one of the sub-host, data storage and network devices, wherein all of the data types requires controlling access thereto. The invention provides for ensuring the integrity and separation of the data stored on the sub-host, data storage and network devices. It also prevents misappropriation of data stored on the devices. The invention includes a control device which selects between the main host and anyone of the sub-host, data storage and network devices for use with a computerized system. Selecting a sub-host, data storage and network device activates and places it in an operational mode. The remaining main host system and sub-host, data storage and network devices and peripherals are placed into a standby operational mode.

Upon selection of one of a sub-host, data storage and network device, the computerized system implements a standby in order to ensure data from one storage device cannot be transferred to another one of a storage device and is not available to users of another storage device. All host, data storage and network devices will require authorization in order to gain access. Implementation of controlled switching is regulated by integrated microprocessors.

### DESCRIPTION OF THE PREFERRED

### Embodiments(S)

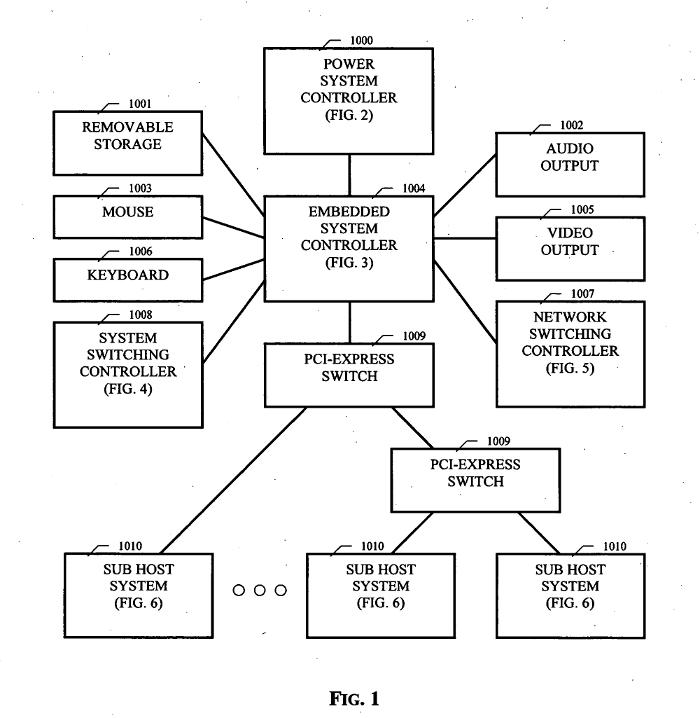

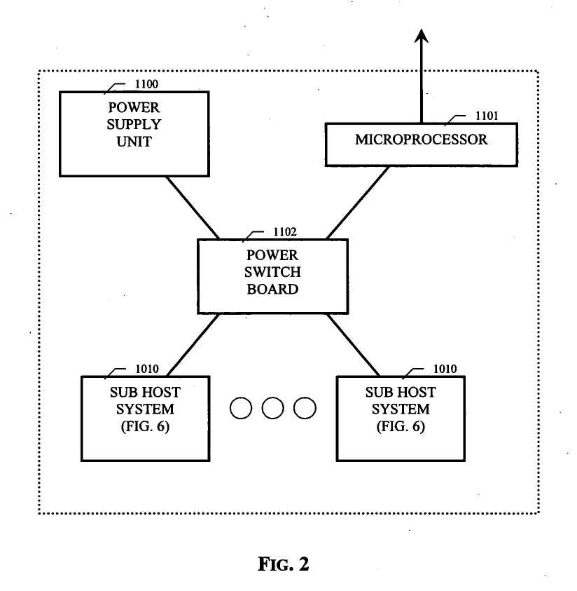

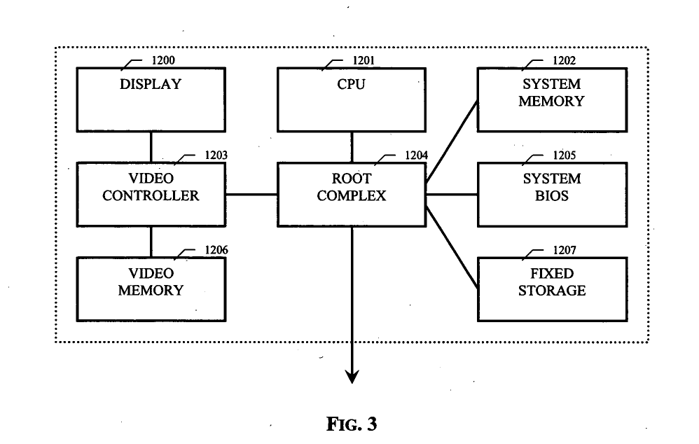

Now referring to FIG. 1, illustrated is a top-level block diagram of the secure computing platform. The computing system includes a main embedded system controller 1004, linked to multiple sub host systems 1010 through a PCI-Express switch 1009. The embedded system controller 1004 interfaces with a common set of user input and output (I/O) devices, such as removable storage 1001, mouse 1003, keyboard 1006, audio output 1002, and video output 1005. A system switching controller 1008 is interfaced to the embedded system controller 1004, communicating which sub host systems 1010 is currently selected. Using this system selection information, the embedded system controller 1004 provides a virtual link between the user I/O devices and the selected sub host system 1010. This link allows the user to assume control over the computational operations run on the sub host systems 1010. A network system controller 1007 provides a managed network portal between each sub host system 1010 to the outside environment. Now referring to FIG. 2, illustrated is a block diagram of the power system controller 1000. The power switch board 1102 is responsible for the flow of power from the power supply unit 1100 to each sub host system 1010. The power board relays the current state of each sub host system 1010 to a local microprocessor 1101. The microprocessor 1101 can be one of numerous processors, such as the AVR series of processors sold by the Atmel Corporation. A command control path between the microprocessor 1101 and the embedded system controller 1004, where the microprocessor acts as a slave. Now referring to FIG. 3, illustrated is a block diagram of the embedded system controller 1004. The system is managed by an embedded central processor unit (CPU) 1201. The CPU 1201 can be one of numerous processors, such as the Pentium® series of processors sold by the Intel Corporation. The CPU 1201 interfaces to a root complex 1204, which may consist of separate north and south bridges, or an integrated combination of both. The root complex 1204 acts as a central bridge, interfacing all the external devices to the CPU 1201. These devices include the system memory 1202, the system BIOS 1205, the fixed storage 1207, and the video controller 1203. The system BIOS 1205 provides the embedded CPU 1201 with instruction code, including start-up instructions. Information contained on the flash BIOS 1205 is only directly accessible by the embedded CPU 1201. The video controller 1203 buffers the current display state into video memory 1206 which it then transmits out to a user display 1200.

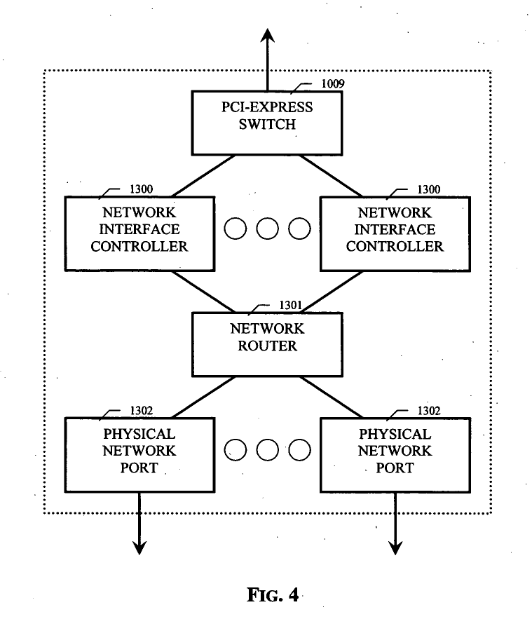

Now referring to FIG. 4, illustrated is a block diagram of the network switching controller 1007.

This module provides the physical network link between the sub host systems 1010 and the outside environment. A PCI-Express switch 1009 is directly interfaced to the embedded system controller 1004, providing a switched link to the network interface controllers 1300. A managed network router 1301 manages the traffic to and from each of the network interface controllers 1300 and the physical network ports 1302. The output from the network router 1301 may comprise a combination of physical and virtual networks.

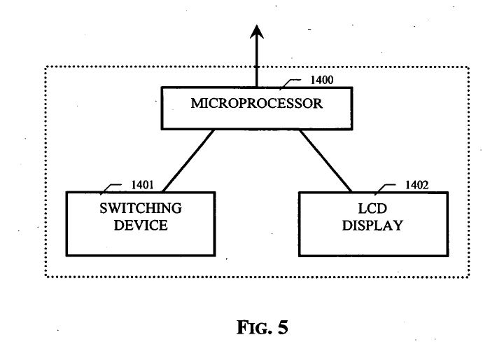

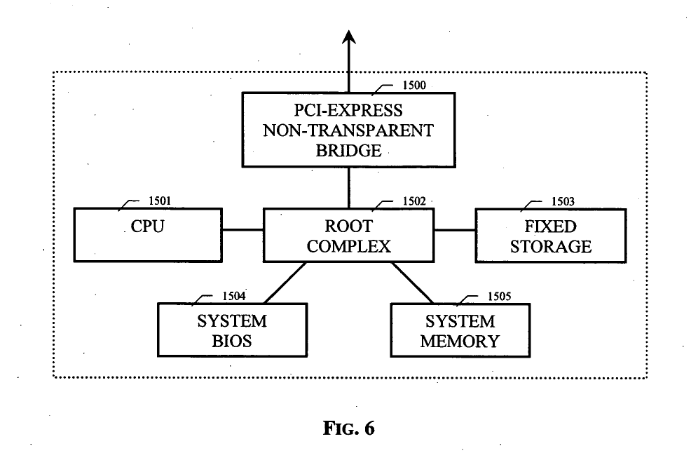

Now referring to FIG. 5, illustrated is a block diagram of the system switching controller 1008. The system includes two user I/O devices, the switching device 1401 and the LCD display 1402. The LCD display 1402 shows the current sub host system 1010 selected by the user via the switching device 1401. Varying security levels are assigned to each sub host system 1010, so only users with the proper credentials can change the sub host system 1010 selection index. The current selected sub host system 1010 index is communicated to the embedded system controller 1004 through a microprocessor 1400. The microprocessor 1400 can be one of numerous processors, such as the AVR series of processors sold by the Atmel Corporation. Now referring to FIG. 6, illustrated is a block diagram of the sub host system 1010. Using a PCI-Express non-transparent bridge 1500, multiple CPU 1501 hosts can share the same PCI-Express bus, but each with its own unique memory space. The CPU 1501 interfaces to a root complex 1502, which can consist of any north and/or south bridge combination such as the Intel 865 series. The root complex 1502 acts as a central bridge, interfacing all the external devices to the CPU 1501. Each sub host system 1010 contains a limited number of core external devices, including the system BIOS 1504, the system memory 1505, and the fixed storage 1503. The system BIOS 1504 provides the embedded CPU 1501 with instruction code, including start-up instructions. Information contained on the flash BIOS 1504 is only directly accessible by the embedded CPU 1501.

### CROSS REFERENCE TO RELATED APPLICATIONS

### U.S. Patent Documents

U.S. Pat. No. 5,075,884 December 1991 Sherman; Richard H et al

U.S. Pat. No. 5,204,663 April 1993 Lee; Philip S.

U.S. Pat. No. 5,894,551 April 1999 Huggins; Frank et al

U.S. Pat. No. 6,009,518 December 1999 Shiakallis; Peter Paul

U.S. Pat. No. 6,351,817 February 2002 Flyntz; Terence T.

U.S. Pat. No. 6,389,542 May 2002 Flyntz; Terence T.

U.S. Pat. No. 6,604,963 August 2003 Lin; Chih-Chiang

Reference to Sequence Listing-Table

| | |
|---|---|
| Application Datasheet | page 1 |
| Application Information | page 2 |
| Correspondence Information | page 3 |
| Domestic Priority | page 3 |
| Foreign Priority | page 3 |
| Description | page 4 |
| Title of Invention | page 7 |
| Cross Reference to Related Applications | page 8 |
| Background of the Invention | page 10 |
| Brief Summary of the Invention | page 15 |
| Detailed Description of the Invention | page 17 |
| Claims | page 18 |
| Abstract of the Disclosure | page 26 |
| Drawings | page 28 |

### BACKGROUND OF THE INVENTION

1. Field of Invention

The invention relates to computerized systems for providing simultaneously operation of multiply environments and multileveled security for accessing and utilizing digitally stored data. This invention allows for access in real time to multiple classifications and types of digitally stored data on multi networks, while allow for complete isolation of the different classification and types of data.

2. Description of the Related Art

In the area of data separation, collection and storage, the ability to ensure the simultaneous access to stored data while improving the integrity and security of proprietary non-classified, trusted, classified and top secret information can be paramount. From governments to corporate and military in conjunction with other environments, the ability to separate non-classified, trusted, classified and top secret information from the everyday and guarantee that only those with proper authority are allowed access to the classified and private information is paramount. To this end, vast corporate and government resources have been spent on various security systems: As a result, systems have been devised which provide for limited access to computerized systems, data and peripherals used by those systems.

U.S. Pat. No. 4,179,735 to Lodi provides a system wherein access to a specific type of information and/or device peripheral is determined based upon a specific need of a user. The system includes a switching device which has a plurality of positions associated with respective working environments and a logic control device which is responsive to the switching device position. In response to the switching device position, the control device selects a particular group of programs and peripherals for the user to access.

U.S Pat No. 6,351,817 to Flyntz is a multilevel computer security system including a computer with multiple security subsystems for secure data storage and data communications at each security level, a smart-card reader for controlling user access to each security level, an electronically-activated switch for activating only the selected and authorized security level, and a mechanically-activated switch that detects the availability of the security level selected. The computer will automatically power-up at the first security level and activate the first security subsystem which is allocated to the processing of restricted data. Access to each level of restricted data requires a user to insert his smart-card into a smart-card reader which will verify the identity through an entered PIN or from stored biometrics data and will allow the user to access only those levels for which the user is authorized as stored in the smart-card. The selection of an authorized level generates an activation signal from the smart-card reader to the electronically activated switch which connects power only to the security subsystem for the security level selected and removes power from all other subsystems. If the required subsystem is not available within the computer the mechanically-activated switch will sense this condition and default to the first security level. Since only one security level is ever active and the switching from one level to another requires the computer RAM to be powered off there can be no possibility of user access to unauthorized data.

U.S. Pat No. 5,075,884 to Sherman is a computer workstation having a window output display for potential use in security-sensitive environments provides multilevel security by physical isolation of processes in predefined security levels, each process or like-classified group of processes is displayed only through a suitably labelled window, access to the window requiring access through a previously security qualified physical signal path. The invention does not compromise security by mixing a software-based security environment with other untested software. All security is hardware-based.

U.S. Pat No. 6,009,518 to Shiakallis is a computer system and method for storing distinct data types is disclosed. The computer system includes a plurality of data storage devices wherein data of a first type may be stored on a first one of the data storage devices and data of a second type may be stored on at least another one of the data storage devices, wherein at least one of the data types requires controlling access thereto. The invention provides for ensuring the integrity of the data stored on the data storage devices. It also prevents misappropriation of data stored on the devices. The invention includes a switch which selects one of the data storage devices for use with a computer system. Selecting a data storage device activates and places it in an operational mode. The remaining data storage devices are placed into a non-operational mode. Upon selection of one of a data storage device, the computer system implements a complete hardware reset in order to ensure data from one storage device cannot be transferred to another one of a storage device and is not available to users of a another storage device. At least one of the data storage devices will require a password and login code in order to gain access.

U.S. Pat No. 5,894,511 to Huggins is a computer system is provided that allows a user to switch between at least two networks having different levels of security without transferring data between the two networks. The computer system comprises a standard computer which includes a central processing unit (CPU) coupled to a random access memory (RAM), a power supply and a reset switch. The computer is coupled to each of two different network cards, each of which is in turn connected to a separate storage device, such as a hard drive. Each combination of a network card connected to a storage device constitutes a network. As in a standard computer, activating the reset switch reboots the CPU and clears the RAM. A user chooses between the two networks by using a rotary switch, a rocker switch, or a push button switch which activates one of the networks or the reset switch. The switch is constructed so that it is impossible to switch between the two networks before first activating the reset switch, thereby preventing data from being transferred between the two networks. By preventing the transfer of data between the two networks, each of the systems can have a different level of security.

One shortcoming of the known art is that it fails to provide simultaneously operation of multiply environments, a system for separation and storing non-classified, trusted, classified and top secret data wherein the types of data are available to different types of users in a real time manner. In order to avoid corruption or misappropriation, a user may only gain access to an information type if the user is a member of the group associated with that information type. Another shortcoming to the know art is the ability to access information without loss of data and time due to system restart and memory clearing. This does not allow for real time critical information to be access when need in areas of high demand and life protecting situations.

### SUMMARY OF THE INVENTION

The invention therefore provides a method and apparatuses for simultaneously operation of multiply environments securing and separating digitally stored data, while limiting the types of users who may obtain access to each data type and ensuring the integrity of the data.

The invention in this respect provides an apparatus which includes a first, second, third and forth digital data storage devices, one, for non-classified information and one, classified information and one for Trusted information and on for Top secret information in a single computerized chaise and which further provides for separation and limited access to the four types of information.

The invention further provides a computerized system including a switching device system for selecting one of four digital data storage devices in order to limit the access to three different types of information stored on the hard drives.

The invention further provides a system which executes a standby operational mode, when a user switches from one digital data storage device to the other, thereby ensuring that no loss of data left in the memory components component of the sub-host occurs. This requires no system reboot or cold system restart.

The invention further provides a computerized system that provides stationary and mobile/portable capabilities wherein functionality of configurations would be the same, wherein separation is limited to two sub-hosts, data storage and network devices within the mobile/portable configuration.

A more complete understanding of the invention can be obtained by considering the following detailed description in conjunction with the accompanying drawings.

What is claimed is:

1. A computerized system simultaneous operation of multiple environments comprising stationary and mobile configuration:

2. A control device with both mechanical and electronic input/output operating device (s);

3. A main board with BIOS (Basic input output system);

4. Multiple sub-host systems and data storage devices with multiple BIOS's (Basic input output systems);

5. A PCI X-Express to PCI X Bridge and standard PCI bridging with Management software interface;

6. A network interface device and individual media access control addressing single and multiple;

7. A network interface device that combines multiple media access control addresses (Mac addresses) into a single interface device within the computerized system.

8. Central processor unit (CPU) single and multiple;

9. Microprocessor unit (MPU) single and multiple;

10. A system of memory components;

11. A peripheral connect interface devices;

12. A power system for main host system and interfacing sub-host system (s) power supply and management;

13. Interface storage device to regulate access control and security for the purpose of exchanging different classifications and types of data;

14. Enhanced digital video control for internal and external display encompassing single and multi-screen displays;

15. Alert system for control and response encompassing the main system to the interfacing sub-host system(s);
